(19) United States
(12) Patent Application Publication
(10) Pub. No.: US 2023/0170127 A1
(43) Pub. Date: Jun. 1, 2023

(54) MAGNETIC ASSEMBLY, POWER MODULE AND SWITCHING POWER SUPPLY

(71) Applicant: Aplus Power Technology (Hangzhou) Co., Ltd., Zhejiang Province (CN)

(72) Inventor: Yuetian WANG, Zhejiang Province (CN)

(21) Appl. No.: 18/072,503

(22) Filed: Nov. 30, 2022

(30) Foreign Application Priority Data
Nov. 30, 2021 (CN) 202111450930.3

(51) Int. Cl. H01F 27/02; H01F 27/28; H01F 27/24; H01F 27/08

(52) U.S. Cl. CPC H01F 27/02; H01F 27/08; H01F 27/24; H01F 27/28

(57) ABSTRACT

The present application provides a magnetic assembly, a power module and a switching power supply. The magnetic assembly includes a magnetic core and a winding, wherein the magnetic core includes a first cover plate, a second cover plate, a plurality of winding posts and a plurality of side posts arranged around the plurality of winding posts, the number of the winding posts is at least 2, and the number of the side posts is at least 4; the first cover plate and the second cover plate of the magnetic core are respectively connected to top and bottom surfaces of the plurality of winding posts and the plurality of side posts of the magnetic core. The application can solve the problem of poor heat dissipation after integration of a plurality of magnetic elements.

### CROSS REFERENCE TO RELATED APPLICATIONS

This application claims priority to Chinese Application Number 202111450930.3, filed on Nov. 30, 2021, the subject matter of which is incorporated herein by reference.

### TECHNICAL FIELD

The present application relates to the technical field of a magnetic assembly, in particular to a magnetic assembly, a power module and a switching power supply.

### BACKGROUND

At present, in order to reduce the size of the magnetic element, generally a magnetic element of a planar structure is formed in a manner in which a plurality of magnetic elements are integrated.

### SUMMARY OF THE INVENTION

It is an object of the present application to provide a magnetic assembly to solve the problem of poor heat dissipation after integration of a plurality of magnetic elements. It is another object of the present application to provide a server, a terminal, a computer apparatus and a readable medium. It is another object of the present application to provide a power module. It is a further object of the present application to provide a switching power supply.

In order to achieve the above objects, an aspect of the present application discloses a magnetic assembly comprising a magnetic core and a winding. The magnetic core comprises a first cover plate, a second cover plate, a plurality of winding posts and a plurality of side posts arranged around the plurality of winding posts, wherein the number of the winding posts is at least 2, and the number of the side posts is at least 4.

The first cover plate and the second cover plate are respectively connected to top and bottom surfaces of the plurality of winding posts and the plurality of side posts of the magnetic core.

Alternatively, the plurality of side posts include a first side post, a second side post, a third side post, and a fourth side post.

The first side post, the second side post, the third side post and the fourth side post enclose a quadrangle, and a plurality of winding posts of the magnetic core are disposed inside the quadrangle.

Alternatively, the plurality of winding posts include a first winding post and a second winding post.

The first cover plate and the second cover plate are respectively connected to top and bottom surfaces of the first winding post, the second winding post and the plurality of side posts of the magnetic core.

Alternatively, the magnetic assembly further includes a first winding and a second winding.

The first winding is wound around the first winding post, and the second winding is wound around the second winding post.

Alternatively, the first winding and the second winding have the same number of turns.

Alternatively, the magnetic assembly comprises a first inductor and a second inductor.

The first winding includes a first coil of the first inductor, and the second winding includes a second coil of the second inductor.

Alternatively, the magnetic assembly further includes a third winding and a fourth winding.

The magnetic assembly includes a second transformer and a third transformer.

The first winding includes a second primary side coil of the second transformer, and the third winding includes a second secondary side coil of the second transformer.

The second winding includes a third primary side coil of the third transformer, and the fourth winding includes a third secondary side coil of the third transformer.

Alternatively, the first winding and the second winding are connected in series, the magnetic assembly further comprises a first pin connected to the first winding and a second pin connected to the second winding; or,

the first winding and the second winding are connected in parallel, and further include a first pin and a second pin respectively connected to the first winding, and a third pin and a fourth pin respectively connected to the second winding.

Alternatively, the magnetic assembly further comprises a first skeleton and a second skeleton, wherein the first skeleton is provided between the third winding and the corresponding cover plate, and the second skeleton is provided between the fourth winding and the corresponding cover plate.

The first skeleton includes a first connection terminal and a second connection terminal connected respectively to both ends of the third winding, and the second skeleton includes a third connection terminal and a fourth connection terminal connected respectively to both ends of the fourth winding.

Alternatively, the magnetic fluxes flowing through the first winding post and the second winding post are equal in magnitude and opposite in direction.

Alternatively, at least one of the plurality of winding posts and the plurality of side posts of the magnetic core is formed with an air gap.

Alternatively, at least two of the plurality of winding posts and the plurality of side posts of the magnetic core are formed with air gaps of equal size.

The present application further discloses a power module comprising a magnetic assembly as described above.

The present application further discloses a switching power supply comprising a power module as described above.

The magnetic assembly of the present application comprises a magnetic core, a first cover plate, and a second cover plate. Wherein the magnetic core comprises a plurality of winding posts and a plurality of side posts arranged around the plurality of winding posts, and the number of the side posts is four or more. The first cover plate and the second cover plate are respectively connected to top and bottom surfaces of the plurality of winding posts and the plurality of side posts of the magnetic core. Thus, a strip-shaped gap is formed between two hollowed-out adjacent side posts of a plurality of side posts of the magnetic core, so that a heat dissipation channel along an extending direction of the side posts can be provided for the magnetic assembly. Since the magnetic core comprises more than four side posts, more than four heat dissipation channels along the first direction in which the side posts extend can be provided for the magnetic assembly, increasing the heat dissipation area. In addition, since an annular gap exists between the winding post and the side post of the magnetic core, the annular gap communicates with the strip-shaped gap between two adjacent side posts, and jointly forming an annular heat dissipation channel in a second direction perpendicular to the extending direction of the side posts. Therefore, the magnetic assembly of the present application has two main heat dissipation channels, which can better take away the heat generated inside the magnetic assembly and improve the heat dissipation effect, which solves the problem of poor heat dissipation after integration of a plurality of magnetic elements, and improves the service life and use safety of the magnetic assembly.

### BRIEF DESCRIPTION OF THE DRAWINGS

To illustrate more clearly the embodiments of the present application or the technical schemes of the prior art, a brief description of the accompanying drawings in the embodiments or the prior art will be given below. Obviously, the accompanying drawings described below are only some embodiments described in this application. For those of ordinary skill in the art, other drawings can also be obtained without any creative labor from these drawings.

FIG. 1 shows a schematic diagram of a specific embodiment of a magnetic assembly of the present application;

FIG. 2 shows a schematic diagram of direction of magnetic flux in two winding posts in a specific embodiment of a magnetic assembly of the present application;

FIG. 3 shows a schematic diagram of magnetic flux distribution in the magnetic assembly of two winding posts in a specific embodiment of a magnetic assembly of the present application;

FIG. 4 shows a schematic diagram of a specific embodiment of the magnetic assembly of the present application including a first winding and a second winding.

Reference numerals:

11. winding post; 12. side post; 13. first cover plate; 14. second cover plate; 15. pin; 16. skeleton; 161. terminal.

### DETAILED DESCRIPTION OF THE PREFERRED EMBODIMENTS

Hereinafter the technical solution in the embodiments of the present application will be described clearly and integrally in combination with the accompanying drawings in the embodiments of the present application, and obviously the described embodiments are merely part of the embodiments, not all of the embodiments. Any other embodiment obtained by those skilled in the art based on the embodiments of the present application without paying any creative labor fall within the protection scope of the present application.

It should be noted that the terms “first,” “second” and the like in the description and claims of the present application and in the above-mentioned drawings are used to distinguish between similar objects and are not necessarily used to describe a particular order or precedence. It should be understood that the data so used may be interchanged where appropriate for the purpose of the embodiments of the present application described herein. Furthermore, the terms “comprising” and “having” and any variations thereof are intended to cover non-exclusive inclusions, such as, for example, a process, a method, a system, a product or a device comprising a series of steps or units need not to be limited to those steps or units that are clearly listed, but may include other steps or units that are not explicitly listed or inherent to these processes, methods, products or devices.

In the present application, the orientation or positional relationship indicated by the terms “on”, “under”, “left”, “right”, “front”, “back”, “top”, “bottom”, “inside”, “outside”, “middle”, “vertical”, “horizontal”, “transverse”, “longitudinal” and the like is based on the orientation or positional relationship shown in the drawings. These terms are mainly intended to better describe the present application and its embodiments and are not intended to limit that the indicated devices, elements or constituents must have a particular orientation, or be constructed and operated in a particular orientation.

The positional relationship such as “parallel” or “vertical” includes not only the positional relationship of exactly “parallel” or “vertical,” but also the positional relationship that the angle deviation relative to exactly “parallel” or “vertical” is within the preset deviation range.

Also, in addition to being used to represent an orientation or positional relationship, some of the above terms may also be used to indicate other meanings. For example, the term “on” may also be used in some cases to denote a certain attachment or connection. The specific meanings of these terms in the present application may be understood by those ordinarily skilled in the art as the case may be.

In addition, the terms “installation”, “setting”, “being provided with”, “connecting”, “connected”, “sleeving” should be understood broadly. For example, the connection may be a fixed connection, a detachable connection or an integrated construction, or may be a mechanical connection or an electrical connection, or may be a direct connection, or may be an indirect connection through an intermediary, or an internal communication between two devices, elements or constituents. The specific meanings of the above terms in the present application may be understood by those ordinarily skilled in the art as the case may be.

It should be noted that the embodiments in the present application and the features in the embodiments can be combined with each other without conflict. Hereinafter, the present application will be described in detail with reference to the drawings and in connection with embodiments.

At present, magnetic elements such as inductors and transformers have a wide range of applications, for example, most servers and communication power supplies are provided with switching power supplies. In order to improve operating frequency, power density and automatic manufacturability of the switching power supply, and at the same time to reduce the manufacturing cost, more and more switching power supplies are designed in a modular way. Modularization refers to that a power semiconductor device of the switching power supply is arranged on a module circuit board, and then the module circuit board is arranged on a main circuit board, wherein the module circuit board is further provided with a magnetic element and a power conversion line.

The server and communication power supply usually need to be arranged on the cabinet, and the height of each layer in the cabinet is usually 1U, therefore, the height of the server and the communication power supply and other equipment need to be set below 1U, the switching power supplies used in the server and the communication power supplies are limited by the height of the server and communication power supplies. The magnetic element occupies considerable volume, weight and loss on the module circuit board, thus it is necessary to reduce the size of the magnetic element on the module circuit board as much as possible and improve the utilization rate of the module circuit board.

In recent years, the design and spatial layout of the magnetic element have undergone rapid development. The structure of the magnetic element has developed from a single independent winding type to various forms such as a planar structure, a matrix structure, a module structure, an integrated structure and a mixed structure and the like. Under the development trend of modularization of the communication power supply and high frequency of switching frequency, the magnetic element of the planar structure has the advantages of small volume and high power density, and thus are widely used in the design of the magnetic element of the module circuit board. However, a magnetic element of a planar structure that is formed by integrating a plurality of magnetic elements and the existing magnetic element are made of ferrite material, which results in a problem that the heat dissipation effect of the magnetic element is poor, and affects service life and use safety of the magnetic element. Based on the problems in the prior art, the embodiment of the present application provides a magnetic assembly, which increases the heat dissipation area of the magnetic assembly, provides two different heat dissipation directions, and thus improves the heat dissipation effect, better takes away the heat generated inside the magnetic assembly, solves the problem of poor heat dissipation after integration of a plurality of magnetic elements, and improves the service life and use safety of the magnetic assembly.

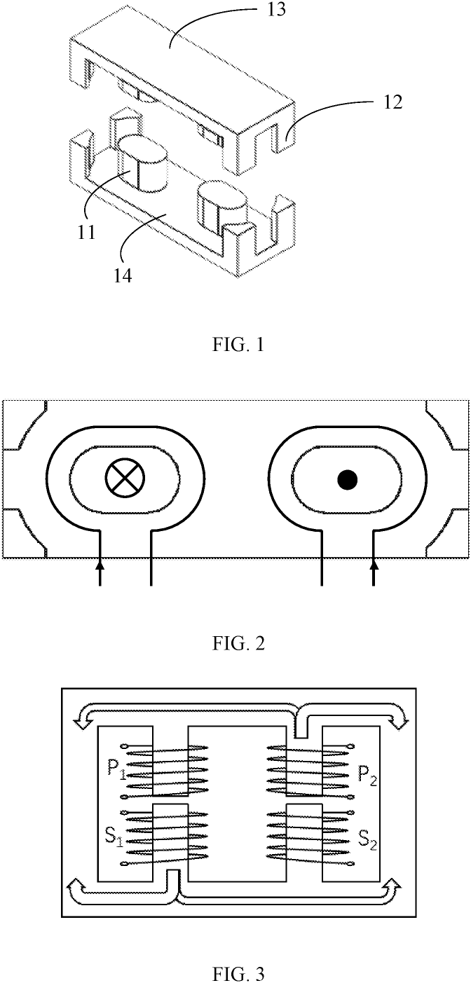

Based on this, according to an aspect of the present application, the present embodiment discloses a magnetic assembly. As shown in FIG. 1, in this embodiment, the magnetic assembly comprises a magnetic core and a winding. The magnetic core comprises a first cover plate 13, a second cover plate 14.

Wherein the magnetic core comprises a plurality of winding posts 11 and a plurality of side posts 12 arranged around the plurality of winding posts 11, the number of the winding posts is at least 2, and the number of the side posts 12 is at least 4.

The first cover plate 13 and the second cover plate 14 are respectively connected to top and bottom surfaces of the plurality of winding posts 11 and the plurality of side posts 12 of the magnetic core.

The magnetic assembly of the present application comprises a magnetic core, a first cover plate 13, and a second cover plate 14. Wherein the magnetic core comprises a plurality of winding posts 11 and a plurality of side posts 12 arranged around the plurality of winding posts 11, and the number of the side posts 12 is four or more. The first cover plate 13 and the second cover plate 14 are respectively connected to top and bottom surfaces of the plurality of winding posts 11 and the plurality of side posts 12 of the magnetic core. Thus, a strip-shaped gap is formed between two hollowed-out adjacent side posts 12 of a plurality of side posts 12 of the magnetic core, so that a heat dissipation channel along an extending direction of the side posts 12 can be provided for the magnetic assembly. Since the magnetic core comprises more than four side posts 12, more than four heat dissipation channels along the first direction in which the side posts 12 extend can be provided for the magnetic assembly, increasing the heat dissipation area. In addition, since an annular gap exists between the winding post 11 and the side post 12 of the magnetic core, the annular gap communicates with the strip-shaped gap between two adjacent side posts 12, and jointly forming an annular heat dissipation channel in a second direction perpendicular to the extending direction of the side posts 12. Therefore, the magnetic assembly of the present application has two main heat dissipation channels, which can better take away the heat generated inside the magnetic assembly and improve the heat dissipation effect, which solves the problem of poor heat dissipation after integration of a plurality of magnetic elements, and improves the service life and use safety of the magnetic assembly.

In an alternative embodiment, the plurality of side posts include a first side post, a second side post, a third side post, and a fourth side post. Wherein the first side post, the second side post, the third side post and the fourth side post enclose a quadrangle, and a plurality of winding posts of the magnetic core are disposed inside the quadrangle.

It can be understood that the magnetic assembly is generally of a rectangle, four corners of which can be respectively provided with a first side post, a second side post, a third side post and a fourth side post. The four side posts, on the one hand, serve to support and protect the inside of the magnetic core, and on the other hand, are connected with the first cover plate and the second cover plate respectively arranged on the top surface and the bottom surface to form a closed magnetic circuit.

Thus alternatively, the first side post, the second side post, the third side post and the fourth side post may enclose a square, with the plurality of winding posts of the magnetic core being wound around the inside of the square. It should be noted that the number of the side posts includes but is not limited to four. When the magnetic core includes a plurality of winding posts and has a large size, more side posts may be provided between the first cover plate and the second cover plate, those skilled in the art can set the number of the winding posts and the side posts according to actual requirements, which is not limited in this application.

In an alternative embodiment, as shown in FIG. 1, the plurality of winding posts include a first winding post and a second winding post. Wherein the first cover plate and the second cover plate are respectively connected to top and bottom surfaces of the first winding post, the second winding post and the plurality of side posts of the magnetic core.

It is to be understood that when the magnetic core comprises a first winding post and a second winding post, each of which can be provided with a winding. One magnetic element or a magnetic assembly integrating two magnetic elements is made by arranging the series and parallel relationship of the windings.

Further, in the present application, by providing the plurality of side posts, the magnetic fluxes of the first cover plate and the second cover plate can be dispersed, and the loss of the magnetic core can be reduced. In addition, as can be seen from FIGS. 2 and 3, the magnetic fluxes flowing through the first winding post and the second winding post can be made equal in magnitude and opposite in direction by controlling the current direction of the windings on the winding posts, thus, the magnetic flux formed on the side posts by the plurality of winding posts can be at least partially canceled so that the loss of the side posts is reduced, and the purpose of reducing the loss of the magnetic core by magnetic integration is achieved.

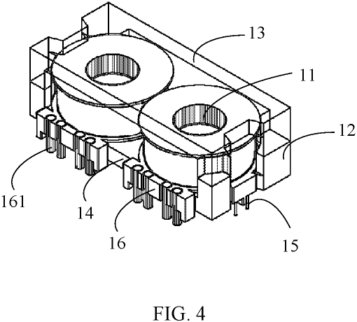

In an alternative embodiment, as shown in FIG. 4, the magnetic assembly further includes a first winding and a second winding. The first winding is wound around the first winding post, and the second winding is wound around the second winding post.

It can be understood that the first winding and the second winding are wound respectively around the first winding post and the second winding post of the magnetic assembly. The magnetic assembly may be configured as a two-way magnetic assembly, that is, two magnetic elements can be integrated. For example, two inductors are integrated or two transformers are integrated together, the space required for a plurality of magnetic elements is reduced in an integrated manner, and the heat dissipation effect of the integrated magnetic assembly is ensured through two different heat dissipation channels.

In an alternative embodiment, the first winding and the second winding are connected in series or in parallel.

Specifically, the first winding and the second winding disposed respectively on the first winding post and the second winding post may be connected in series, the first winding and the second winding are in the same circuit and can be used as one or two magnetic elements in series. Of course, the first winding and the second winding can also be connected in parallel, in which case the first winding and the second winding are in different circuits and can be used as two parallel magnetic elements.

In an alternative embodiment, the first winding and the second winding have the same number of turns.

It can be understood that the first winding and the second winding may have the same number of turns in order to make the two-way magnetic assembly have the same magnetic performance, for example, to obtain two inductors having the same inductance value. Of course, in practical applications, those skilled in the art may determine the number of turns of the first winding and the second winding according to practical requirements, which is not limited by the present application.

In an alternative embodiment, at least one of the plurality of winding posts and the plurality of side posts of the magnetic core is formed with an air gap.

It can be understood that, in order to reduce the tolerance of the inductance, an air gap can be formed on at least one of the plurality of winding posts and the plurality of side posts, and a pad air gap is not needed by opening the air gap, thereby simplifying the manufacturing process. Of course, those skilled in the art can determine whether or not to provide an air gap on the winding post and the side post according to actual requirements, and this application is not limited to these.

In an alternative embodiment, at least two of the plurality of winding posts and the plurality of side posts of the magnetic core are formed with air gaps of equal size.

It can be understood that when it is necessary to form air gaps on at least two of the plurality of winding posts and the plurality of side posts respectively, in order to make the magnetic performance of the plurality of winding posts and the plurality of side posts equal to each other as much as possible, alternatively air gaps of equal size may be provided.

In a specific example, the magnetic assembly comprises a first inductor and a second inductor. The first winding includes a first coil of the first inductor, and the second winding includes a second coil of the second inductor. In this specific example, the two-way magnetic assembly may be a two-way inductor, that is, the two-way magnetic assembly can be used to make a magnetic assembly integrated by two inductors. For example, an interleaved two-way interleaved PFC (Power Factor Correction) inductor may be formed for use in a two-way interleaved PFC circuit, the two-way interleaved PFC circuit is a common technique in the field, and is not described herein.

Specifically, a first coil may be wound around the first winding post as the first winding, a second coil may be wound around the second winding post as the second winding, and then the magnetic core, the first cover plate and the second cover plate may be combined so that a closed magnetic circuit may be formed in the the magnetic core, the first cover plate and the second cover plate to obtain a two-way inductor.

In another specific embodiment, the magnetic assembly further comprises a third winding and a fourth winding. The magnetic assembly includes a second transformer and a third transformer. The first winding includes a second primary side coil of the second transformer, and the third winding includes a second secondary side coil of the second transformer. The second winding includes a third primary side coil of the third transformer, and the fourth winding includes a third secondary side coil of the third transformer.

It can be understood that the primary side coil P1 and the secondary side coil S1 of the second transformer are arranged on the first winding post, and the primary side coil P2 and the secondary side coil S2 of the third transformer are arranged on the second winding post, so that the integration of the two transformers can be realized. The second primary side coil (first winding) and the third primary side coil (second winding) may be connected in series or in parallel. Similarly, the second secondary side coil (third winding) and the third secondary side coil (fourth winding) may be connected in series or in parallel.

When the second primary side coil and the third primary side coil are connected in series, and the second secondary side coil and the third secondary side coil are also connected in series, the second transformer and the third transformer may be used as one transformer, or may also be used as two transformers in series. When the second primary side coil and the third primary side coil are connected in series, the second secondary side coil and the third secondary side coil are connected in parallel, or the second primary side coil and the third primary side coil are connected in parallel, the second secondary side coil and the third secondary side coil are connected in series, or both the second primary side coil and the third primary side coil are connected in parallel, the magnetic assembly comprises a second transformer and a third transformer that are integrated.

In an alternative embodiment, the magnetic assembly may further be provided with a pin 15, the first winding and the second winding are connected in series, and the pin may include a first pin and a second pin connected respectively to both ends of the first winding and the second winding connected in series; or the first winding and the second winding are connected in parallel, and further include a first pin and a second pin respectively connected to the first winding, and a third pin and a fourth pin respectively connected to the second winding.

It can be understood that the first winding and the second winding each comprise a current input end and a current output end. When the first winding and the second winding are connected in series, the current output end of the first winding may be connected to the current input end of the second winding, and only the current input end of the first winding and the current output end of the second winding need to be connected to an external circuit, then only the first pin and the second pin can be provided to respectively electrically connect the current input end of the first winding and the current output end of the second winding to the external circuit. When the first winding and the second winding are connected in parallel, it is necessary to respectively provide a first pin and a second pin connected to the current input end and the current output end of the first winding, and a third pin and a fourth pin connected to the current input end and the current output end of the second winding, so as to realize the electrical connection of the first winding and the second winding respectively to an external circuit.

In an alternative embodiment, the magnetic assembly may be further provided with a skeleton 16. In this embodiment, the skeleton comprises a first skeleton and a second skeleton, wherein the first skeleton is provided between the third winding and the corresponding cover plate, and the second skeleton is provided between the fourth winding and the corresponding cover plate.

Furthermore, the skeleton may be provided with terminals 161. Specifically, the first skeleton includes a first connection terminal and a second connection terminal connected respectively to both ends of the third winding, and the second skeleton includes a third connection terminal and a fourth connection terminal connected respectively to both ends of the fourth winding.

It can be understood that the first skeleton is arranged between the third winding and the cover plate, the second skeleton is arranged between the fourth winding and the cover plate, the first skeleton and the second skeleton may be formed of insulating materials so that the third winding and the fourth winding may be insulated from the cover plate. Further, the first skeleton is provided with a first connection terminal and a second connection terminal connected respectively to both ends of the current input terminal and the current output terminal of the third winding, and the second skeleton is provided with a third connection terminal and a fourth connection terminal connected respectively to both ends of the current input end and the current output end of the fourth winding, and can be used for electrical connection of the third winding and the fourth winding to an external circuit.

In the present application, a plurality of side posts are arranged to form a gap between the side posts, terminals of the pin and the skeleton can be arranged in the gap, and the external space occupied by the pin and the skeleton of the magnetic assembly can be reduced, so as to improve the utilization of space.

It should be noted that in this embodiment, two transformers are integrated to illustrate that the winding on the winding post is electrically connected to an external circuit through a pin and a skeleton. In practical applications, a person skilled in the art would have been able to arrange an electrical connection structure, such as a pin and a skeleton, according to the actual arrangement of a winding post and a winding to achieve the electrical connection between the winding and an external circuit, and this is not defined in the present application.

Based on the same principle, this embodiment further discloses a power module. The power module includes the magnetic assembly as described in this embodiment.

Specifically, the power module may include the magnetic assembly of this embodiment, and may also include devices such as a capacitor, a switching element and the like, wherein the magnetic assembly may provide a magnetic device in which the inductor and the transformer are integrated.

As an alternative embodiment, the power module may be disposed on a module circuit board, and the module circuit board may be disposed on a main circuit board to form a switching power supply.

Since the power module solves the problem in accordance with the principle similar to the method described above, the implementation of the power module may be found by referring to the implementation of the method, and is not repeated herein.

Based on the same principle, this embodiment further discloses a switching power supply. The switching power supply includes a power module as described in this embodiment.

It can be appreciated that the switching power supply may include a main circuit board on which a power module may be provided. Alternatively, the power module may be first disposed on the module circuit board, and then the module circuit board is disposed on the main circuit board to form the switching power supply, so that the power module of this embodiment is disposed in the switching power supply.

Since the switching power supply solves the problem in accordance with the principle similar to the magnetic assembly described above, the implementation of the switching power supply may be found by referring to the implementation of the magnetic assembly, and is not repeated herein.

The various embodiments in the specification are described in a progressive manner, and the same or similar parts between the various embodiments may be referred to each other, and each embodiment focuses on the differences from the other embodiments. In particular, the system embodiment is simply described since it is substantially similar to the method embodiment, and please refer to the description of the method embodiment for the relevant content.

The above descriptions are only embodiments of the present application and are not intended to limit the application. Various changes and modifications can be made to the present application by those skilled in the art. Any modifications, equivalents, improvements, etc. made within the spirit and scope of the present application are intended to be included within the scope of the claims of the present application.

What is claimed is:

1. A magnetic assembly characterized in comprising a magnetic core and a winding, wherein the magnetic core comprises a first cover plate, a second cover plate, a plurality of winding posts and a plurality of side posts arranged around the plurality of winding posts, the number of the winding posts is at least 2, and the number of the side posts is at least 4;
the first cover plate and the second cover plate are respectively connected to top and bottom surfaces of the plurality of winding posts and the plurality of side posts of the magnetic core.

2. The magnetic assembly according to claim 1, characterized in that, the plurality of side posts include a first side post, a second side post, a third side post, and a fourth side post;
the first side post, the second side post, the third side post and the fourth side post enclose a quadrangle, and a plurality of winding posts of the magnetic core are disposed inside the quadrangle.

3. The magnetic assembly according to claim 1, characterized in that, the plurality of winding posts include a first winding post and a second winding post;
the first cover plate and the second cover plate are respectively connected to top and bottom surfaces of the first winding post, the second winding post and the plurality of side posts of the magnetic core.

4. The magnetic assembly according to claim 3, characterized in that, the magnetic assembly further comprises a first winding and a second winding;
the first winding is wound around the first winding post, and the second winding is wound around the second winding post.

5. The magnetic assembly according to claim 4, characterized in that, the first winding and the second winding have the same number of turns.

6. The magnetic assembly according to claim 4, characterized in that, the magnetic assembly comprises a first inductor and a second inductor;
the first winding includes a first coil of the first inductor, and the second winding includes a second coil of the second inductor.

7. The magnetic assembly according to claim 4, characterized in that, the magnetic assembly further comprises a third winding and a fourth winding;
the magnetic assembly includes a second transformer and a third transformer;
the first winding includes a second primary side coil of the second transformer, and the third winding includes a second secondary side coil of the second transformer;
the second winding includes a third primary side coil of the third transformer, and the fourth winding includes a third secondary side coil of the third transformer.

8. The magnetic assembly according to claim 4, characterized in that, the first winding and the second winding are connected in series, the magnetic assembly further comprises a first pin connected to the first winding and a second pin connected to the second winding; or
the first winding and the second winding are connected in parallel, and further include a first pin and a second pin respectively connected to the first winding, and a third pin and a fourth pin respectively connected to the second winding.

9. The magnetic assembly according to claim 7, characterized in that, the magnetic assembly further comprises a first skeleton and a second skeleton, wherein the first skeleton is provided between the third winding and the corresponding cover plate, and the second skeleton is provided between the fourth winding and the corresponding cover plate;
the first skeleton includes a first connection terminal and a second connection terminal connected respectively to both ends of the third winding, and the second skeleton includes a third connection terminal and a fourth connection terminal connected respectively to both ends of the fourth winding.

10. The magnetic assembly according to claim 8, characterized in that, the magnetic fluxes flowing through the first winding post and the second winding post are equal in magnitude and opposite in direction.

11. The magnetic assembly according to claim 1, characterized in that, at least one of the plurality of winding posts and the plurality of side posts of the magnetic core is formed with an air gap.

12. The magnetic assembly according to claim 11, characterized in that, at least two of the plurality of winding posts and the plurality of side posts of the magnetic core are formed with air gaps of equal size.

13. A power module, characterized in comprising a magnetic assembly according to claim 1.

14. A switching power supply, characterized in comprising a power module according to claim 13.
